(19) United States
(12) Patent Application Publication
(10) Pub. No.: US 2017/0340521 A1
(43) Pub. Date: Nov. 30, 2017

(54) Clip-on nipple assembly

(71) Applicant: Michael S. Farhi, Westchester, IL (US)

(72) Inventor: Michael S. Farhi, Westchester, IL (US)

(21) Appl. No.: 14/999,545

(22) Filed: May 24, 2016

(51) Int. Cl. A61J 11/04

(52) U.S. Cl. CPC A61J 11/04

(57) ABSTRACT

A clip-on nursing nipple assembly is disclosed which is readily portable by itself without being attached to a fluid supply and is adapted to be affixed to commonly sold water bottles or the like. The assembly has a funnel member with a nursing orifice at one end and a flanged base at the other. A skirt attached to the base forms a socket which fits over the spout of a commercially available water bottle or similar container. There is a clamping member which includes a funnel member engagement portion disposed on the funnel member, a jaw portion engageable on the spout of a water bottle, and a yoke portion connecting the funnel member engagement portion and the jaw portion and urging the base member into sealing engagement on the spout.

This application is a continuation-in-part of the same inventor's co-pending U.S. patent application Ser. No. 14/121,150, filed Aug. 7, 2014, and claims the priority of the filing date of that application as well as the priority of (1) the filing date of U.S. Provisional Application Ser. No. 61/99,514, filed Apr. 5, 2014, and (2) the filing date of U.S. Provisional Application Ser. No. 61/996,650, filed May 13. 2014, which are claimed at the outset in application Ser. No. 14/121,150. The entire content of each of these applications is incorporated herein by reference.

Except for the applications just referred to, there are no patent applications related to this one. None of these applications is subject to any federally sponsored research or development or to any joint research agreement.

### FIELD OF INVENTION

The invention described herein relates to nursing nipples which are applied to bottles of infant formula, water or similar fluids given to infants. More particularly, it relates to nipple assemblies which may be carried by themselves, independently from any fluid supply, and are adapted to be placed on the necks or spouts of bottles which are readily available containing soft drinks, mineral water, or the like.

### FIELD OF INVENTION

In U.S. Pat. No. 5,024,341, the patentee describes a nipple adapter for a bottle of mineral water having a threaded neck, said to be about 26-28 mm in diameter. In that patent, an adapter ring is shown which is screwed onto a bottle neck, and there is another threaded ring member screwed onto exterior threads on the adapter. The second threaded ring member threadably grasps a collar on the lower end of the nipple, thus holding the nipple on the bottle.

A generally similar arrangement is disclosed in U.S. Pat. No. 6,354,449. There, the patentee describes a housing which screws onto the threaded neck of a bottle and also has external threads which engage other threads on the inner walls of a cup-shaped cap. The cap, which rests on top of a flange extending outwardly from the bottom end of a nipple, is arranged to screw down upon the external threads of the housing, thereby pulling the flange of the nipple down against a seal located on the top end of the housing. While the patent describes its device as “a nipple adapter in the form of a unitary assembly,” there are a number of parts in the device which have to be assembled before the device is complete.

The adapter shown in the “341 patent and the housing shown in the “449 patent are reflected in various forms in other patents such as U.S. Pat. Nos. 6,415,937; 6,851,565 and 7,185,775. In U.S. Pat. No. 7,481,324, the lower portion of an adapter is press-fit into the neck of a bottle, and its upper end is screwed into the internal threads of a cap which holds the bottom end of a nipple inside the cap. In U.S. Pat. No. 7,552,831 a special nipple, with a sealing flange about its middle and thread engaging sealing flanges at its lower end, is fastened onto the threaded outside of a bottle neck by a separate internally threaded sleeve which draws the nipple and bottle together with its threads.

A variety of other bottle cap systems may be found in United States Classes 206, 215, 222 and 227.

### SUMMARY OF THE INVENTION

Each of the above described inventions strives to sealingly connect a nursing nipple to an ordinary commercial bottle. Such bottles usually have a short tubular neck with external threads, or engageable lugs, or have internal passageways engageable with press-fitting connectors. Each of the patentees seems to have recognized the desirability of connecting nipples to bottles which are easily obtained wherever and whenever a need arises and thus avoid any necessity for carrying pre-prepared, pre-filled bottles. Yet all of the disclosed inventions seem to incorporate connectors which complicate the sealing interface between a nipple and the neck of a bottle. It is an object of the present invention to simplify that interface connection and also enable a user to make fluid-tight easy-to-make connections to a variety of readily available bottles at a moment's notice.

Thus, the present invention incorporates several elements in a nipple assembly which may be used with bottles that are readily available to a user. It utilizes a funnel member having an orifice at a first end for transmitting fluid out of the funnel member, a base member at a second end of the funnel member, and a clamping member which includes a funnel member engagement portion disposed on the funnel member, a jaw portion engageable on the spout of a water bottle, and a yoke portion connecting the funnel member engagement portion and the jaw portion and urging the base member into sealing engagement on the spout.

### BRIEF DESCRIPTION OF THE DRAWINGS

The invention described herein will be well understood from the following description, given by way of example, with reference to the accompanying drawings in which:

FIG. 1 is a perspective view of a nursing nipple;

FIG. 2 is a sectional view in elevation of the nursing nipple of FIG. 1 taken along the line 2-2 in FIG. 1;

FIG. 3 is an enlarged sectional view of a portion of the nursing nipple shown in FIG. 2 showing the skirt member of the nursing nipple constrictively applied to the neck portion of a bottle shown in phantom;

FIG. 4 is an enlarged sectional view of a portion of the nursing nipple shown in FIG. 2 modified by including an ordinary bottle cap constrictively engaged in a socket formed within the skirt member of the nursing nipple shown in FIG. 2;

FIG. 5 is a perspective view of the nursing nipple of FIG. 1 modified by including a cable tie loosely disposed in and on the skirt member of the nipple;

FIG. 6 is an enlarged sectional view of the nursing nipple of FIG. 5 modified by a constrictive position of the cable tie holding the skirt member snugly about the neck portion of a bottle shown in phantom;

FIG. 7 is a sectional view of the nipple unit of FIG. 6 taken along the line 7-7 in FIG. 6;

FIG. 8 is a perspective view of the nursing nipple assembly of FIG. 1 which utilizes an improved clamping member engaged over the skirt of the nipple member and on a bottle, the bottle being shown in section;

FIG. 9 is a perspective and enlarged view of the nursing nipple member of the assembly in FIG. 8;

FIG. 10 is a sectional view in elevation of the nursing nipple member in FIG. 9 taken along line 10-10 in FIG. 9;

FIG. 11 is an enlarged view of a portion of the nursing nipple member of FIG. 10;

FIG. 12 is an exploded view in perspective of the nursing nipple and clamping member of the assembly in FIG. 8 arranged for engagement on the neck portion of a bottle, the bottle being shown in section;

FIG. 13 is an elevational view partially in section of the nursing nipple and clamping member of FIG. 8 in an initial position being applied to the neck portion of a bottle;

FIG. 14 is a sectional view in elevation of the nursing nipple and clamping member shown in FIG. 13 fully applied to the neck portion of a bottle taken in the direction of arrows 14-14 in FIG. 13;

FIG. 15 is an enlarged sectional view in elevation, and partially in perspective, of a portion of the clamping member and nipple disposed on the spout of the bottle, and looking from the opened sectioned side on through the distant side of the spout at portions of the nipple and clamping member;

FIG. 15A is an enlarged perspective view of the improved clamping member of the nipple assembly shown in FIG. 15;

FIG. 15B is an elevational view of the improved clamping member shown in FIG. 15A; FIG. 15C is a sectional view, partially in perspective of the improved clamping member shown in FIG. 15B; and

FIG. 16 is a sectional view in elevation of an alternative embodiment of the nursing nipple and clamping member assembly shown in FIGS. 8 through 16.

### DESCRIPTION OF THE PREFERRED EMBODIMENTS

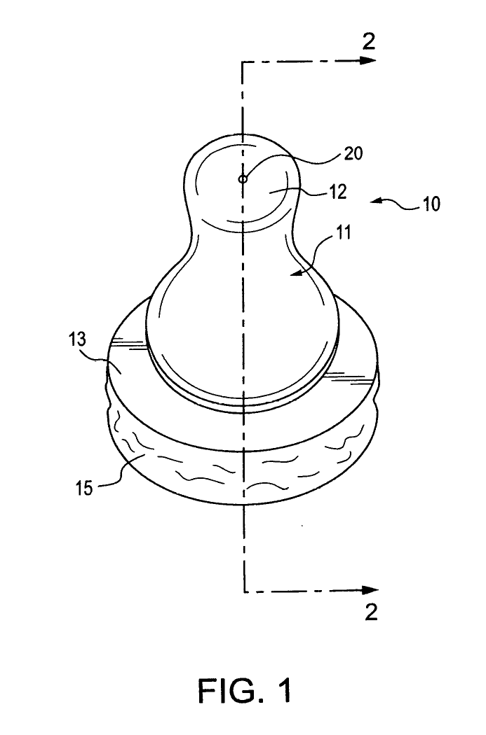

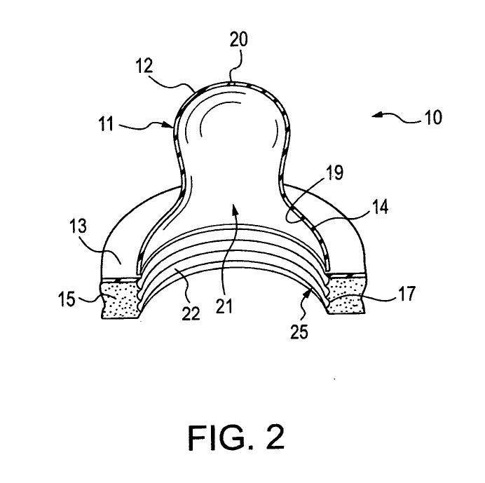

A nipple unit 10 which embodies the present invention is shown in FIG. 1. The upper portion of the unit includes a nipple shaped funnel member 11 with an orifice 20 at its first end 12. A base member 13, shown as a flat flange extending outwardly from funnel member 11, is disposed adjacent the funnel member's second end 14. The funnel member 11 and base member 13 are usually formed together and often made of a flexible silicone compound which can be readily used by an infant to nurse. A flexible skirt member 15 is attached to the base member 13 on its underside, as shown in FIGS. 2 through 4, so that the skirt extends away from the base member 13. The skirt may be affixed on the underside of the base member, as shown in FIG. 2, or only to the periphery of the base member, as shown in FIG. 1.

The inner wall 17 of skirt 15 forms a socket 22 inside the skirt adjacent to the base member 13. Together, the inner walls 17 of skirt 15 and the inner walls 19 of funnel member 11 form a channel, shown at 21, in the unit 10 extending through the skirt member 15, base member 13 and funnel member 11 for transmitting fluid to orifice 20 at the funnel member's first end 12.

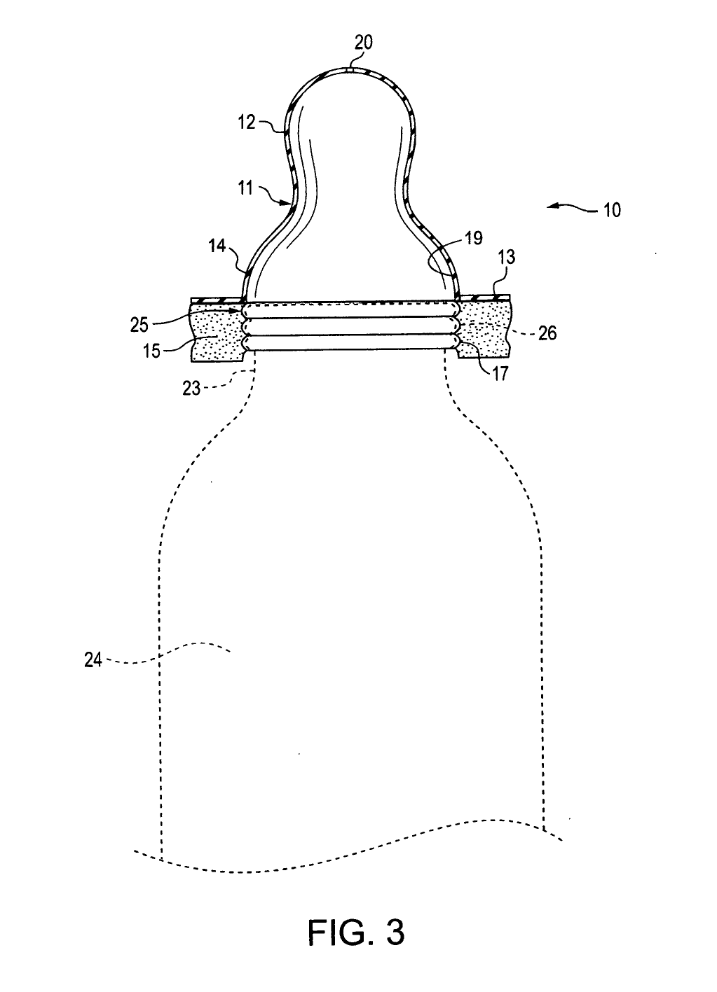

As shown in FIGS. 2 and 3, the nipple unit 10 may be mounted on the spout 23 of a bottle 24 utilizing threads 25 on the skirt walls 17 and arranged for sealing engagement on the complementary threads 26 on the bottle's spout 23. The threads may be continuous members, as in FIG. 2, or spread-apart lugs as shown in section in FIG. 3, inside the skirt 15, so long as a sealing engagement is achieved and maintained between the inner walls 17 of the skirt 15 and spout 23. Those skilled in the art will recognize, too, that a frictional, sealing engagement between walls 17 and spout 23 can also be achieved without the use of threads or lugs so long as skirt member 15 is sufficiently constrictive.

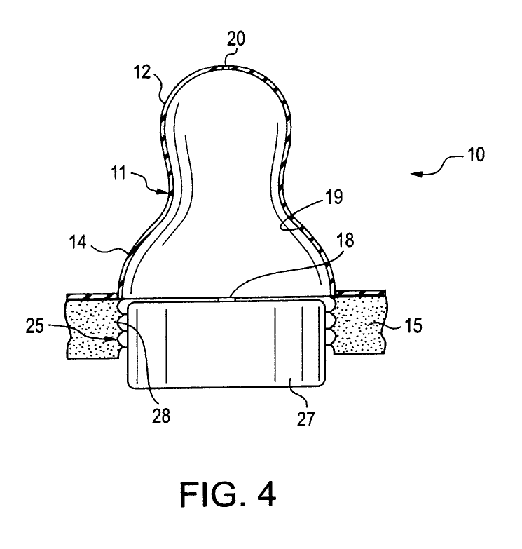

In FIG. 4, the nipple unit 10 as shown in FIG. 1 is modified by including a bottle cap 27 inside skirt 15. That cap 27 may be sized to fit the spouts of bottles having relatively common diameters in the range of 26-28 mm. The cap 27 is fixed inside skirt 15 by external corrugations 28 on the cap being embedded in the skirt member 15 of nipple 10. Oftentimes the corrugations result by forming cap 27 out of metal when the cap is manufactured in order to form threaded configurations on the inside of the cap, although, if the cap is made of molded plastic, external configurations are frequently provided in the molding process in order to achieve an easily gripped outer surface. Corrugations 28 may be regarded as illustrative of these alternatives. To engage them, the skirt member 15 of assembly 10 may be formed, as shown in FIG. 2, with lands and grooves, i.e., thread elements formed in walls of the skirt member 15 around the socket 22, which are complementary to the corrugations 28 and interfit with them when cap 27 is twisted into engagement thereon. Alternatively, cap 27 may be fixed on the base member with an adhesive or by molding the cap and the base member together at the time the base member 13 and funnel member 11 are manufactured.

The lid portion of cap 27 is provided with a hole 18 accessing the second end 14 of funnel 11 and leading into the cavity inside funnel 11. The hole 18 thus allows fluid to be drawn from a bottle (not shown) when cap 27 is affixed thereto, on into funnel 11, and from there drawn through orifice 20 in the first end of funnel 11 into an infant's mouth as the infant nurses.

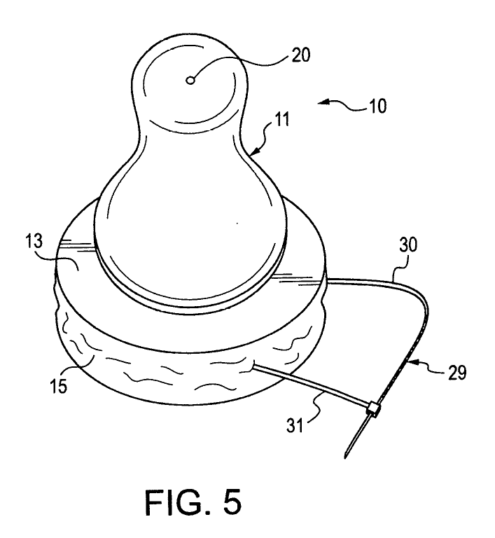

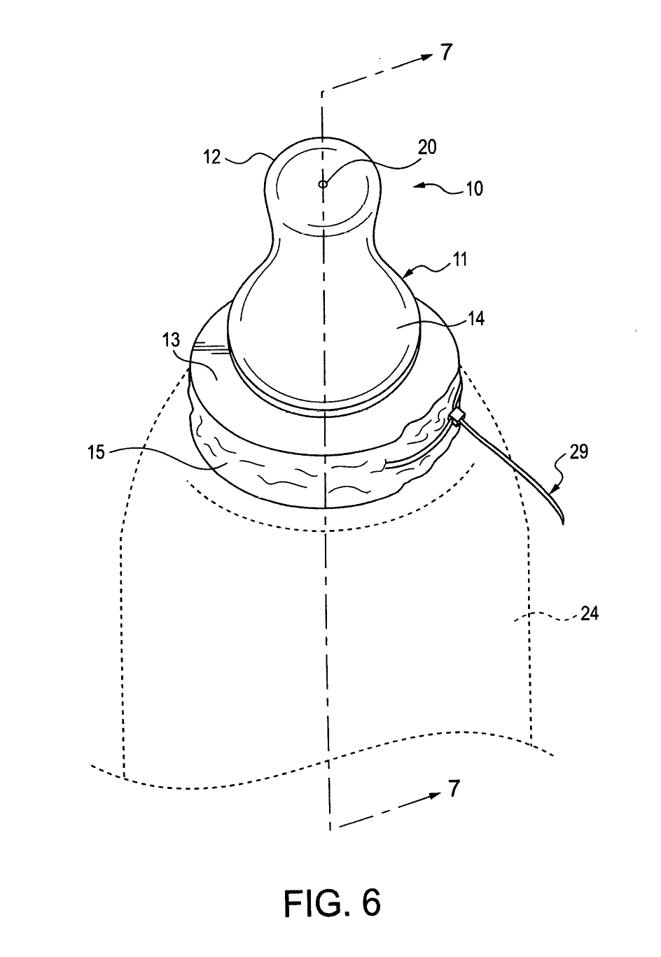

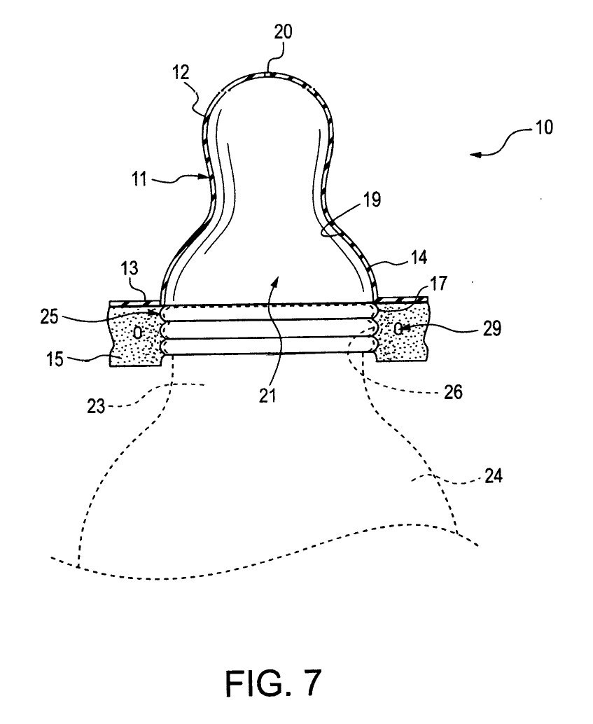

The flexibility of skirt 15, which allows the skirt to slip over a variety of sizes and configurations of bottle spouts, may be further enhanced by engaging a clamping member 29 on the skirt 15 or embedding the clamping member in the skirt, as shown in FIG. 5. A clamping member so arranged provides for constricting the socket inside the skirt onto a spout when the clamping member is tightened. A plastic strip such as a cable tie may be used, illustrated here as clamping member 29. It may be disposed outside of skirt 15, as shown by the upper leg 30 of clamping member 29, or it may be embedded in skirt 15 as shown by the lower leg 31 of clamping member 29 in FIG. 5. A clamping member such as cable tie 29 can be easily tied around a bottle spout as shown in FIGS. 6 and 7 and not loosened by an infant, thus making the assembly 10 secure and safe for infant use. An elastic band wound entirely and tightly around the outside of skirt 15 in place of the cable tie 29 may be utilized as an alternative form of clamping member.

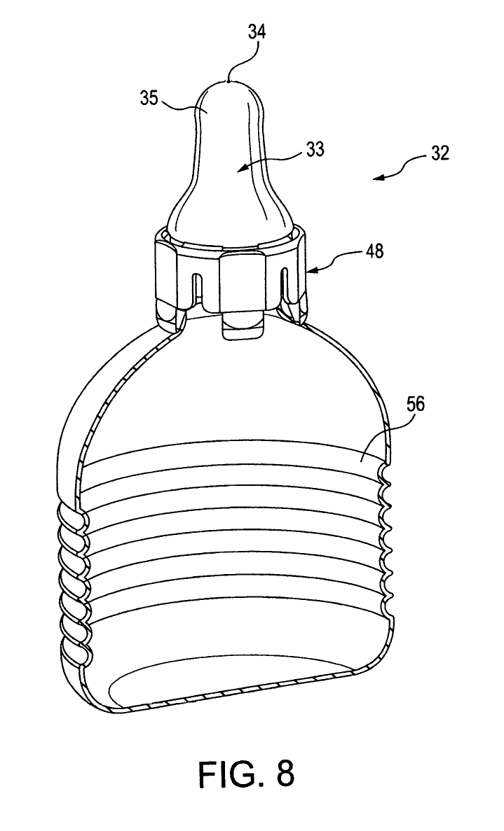

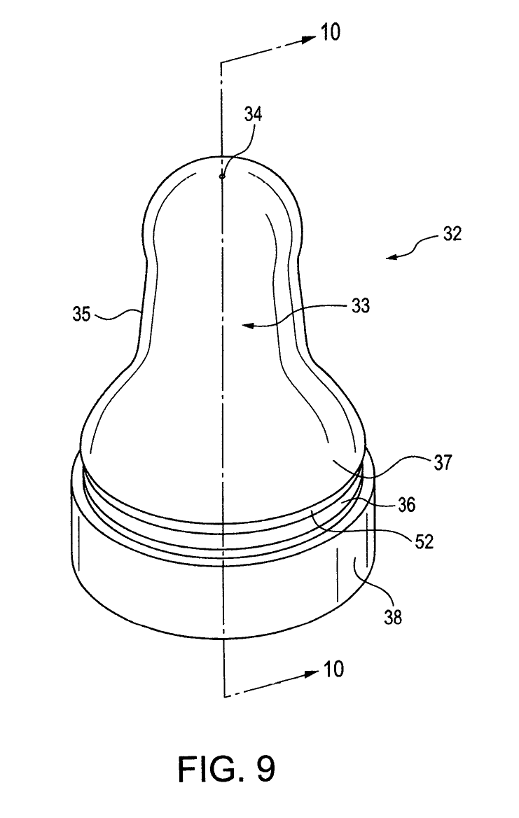

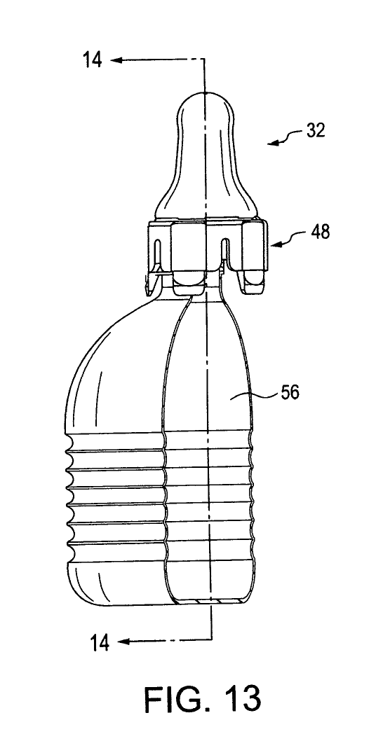

A nursing nipple assembly 32 which also embodies the present invention is shown in FIGS. 8 through 15C. The assembly 32 includes a nipple shaped funnel member 33 with an orifice 34 at its first end 35. A base member 36, shown as a flat flange extending outwardly from funnel member 33, is disposed adjacent the funnel member's second end 37. The funnel member 33 and base member 36 are usually formed together and often made of a flexible silicone compound which can be readily used by an infant to nurse. A flexible skirt member 38 is attached to the base member on its underside, as shown in FIGS. 9 through 11, so that the skirt extends away from the base member 36.

The inner walls 40 of skirt 38 form a socket 42 inside the skirt adjacent to the base member 36. Together, the inner walls 40 of the skirt 38 and the inner walls 44 of the funnel member 33 form a channel, shown at 46 in assembly 32, extending through the skirt member 38, the base member 36 and the funnel member 33 for transmitting fluid to orifice 34 at the funnel member's first end 35.

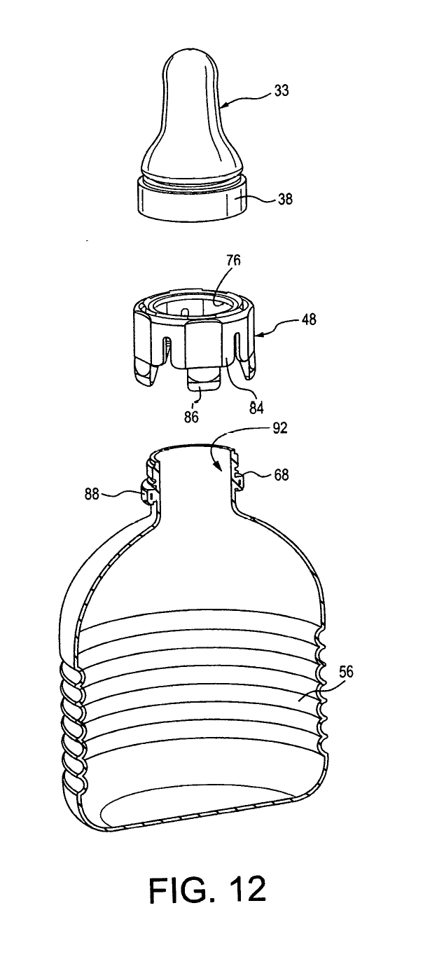

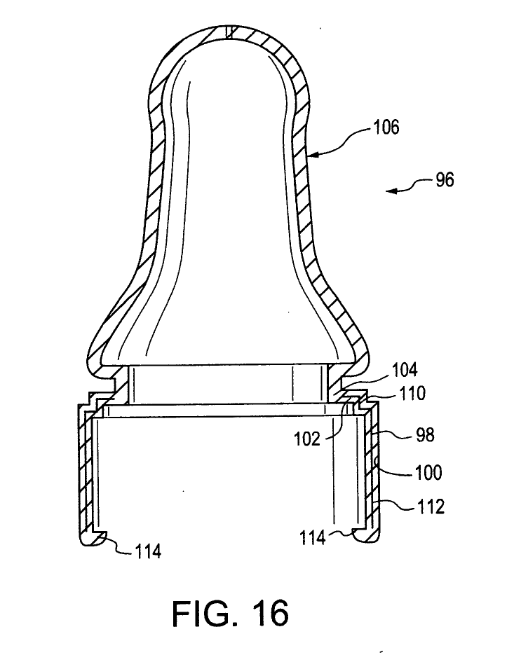

The flexibility of skirt 38, which allows the skirt to slip over a variety of sizes and configurations of bottle spouts and threads, may be further enhanced by engaging a clamping member 48 on the skirt 38, as shown in FIG. 12 for example, or embedding a similar clamping member 98 in the skirt 100, as shown in FIG. 16. A clamping member so arranged either way allows the walls 40 of the socket to be tightly engaged on the outside of the spout after the skirt has been slipped onto it.

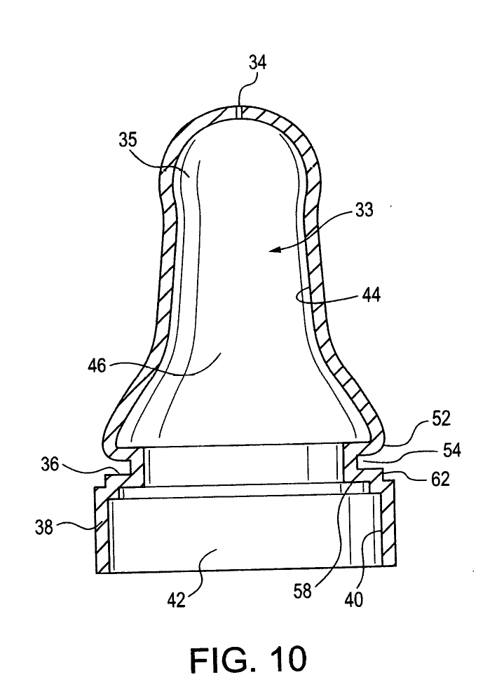

The clamping member 48, as illustrated in FIG. 8 and as described above, holds the funnel member 33 securely on the spout of a bottle. In the enlarged views, FIGS. 9 and 10, the funnel member 33 includes a ring element 52, which may take the form of a continuous or discontinuous bulbous portion disposed on the funnel member's exterior adjacent its second end 37, just above and spaced apart from the base member 36. That arrangement assists in forming a channel 54 around the outside of the funnel member 33 suitable for receiving a collar or lug 76 in the clamping member 48. The collar 76 grasps the funnel member and holds its base member 36 upon the upwardly facing edges of a spout 92 on a bottle 56, thus creating a first sealing engagement point 58 of the assembly 32 on the bottle at that junction.

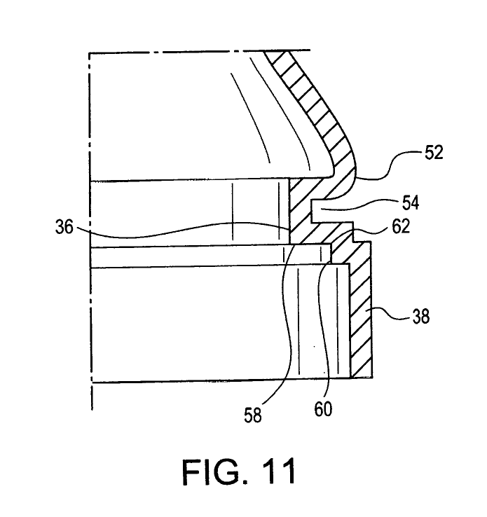

The first sealing engagement point 58, just described, may be supplemented by a second sealing engagement point 60, shown in FIG. 11, between the inner walls of the skirt 38 and the horizontally facing outside surfaces of the spout 92 above the threads on the spout and adjacent to the first sealing engagement point 58. There, an indent 62 may be formed on the funnel member's second end 37 adjacent base member 36's junction with the skirt 38. When horizontally inward pressure toward the open mouth of the spout is exerted on the indent, the upper end of the skirt member above the bottle threads is pushed inwardly for a firmer engagement of the skirt member onto the sides of the spout and creates a seal against the spout 92 on the spout's outwardly facing sides adjacent to its open end.

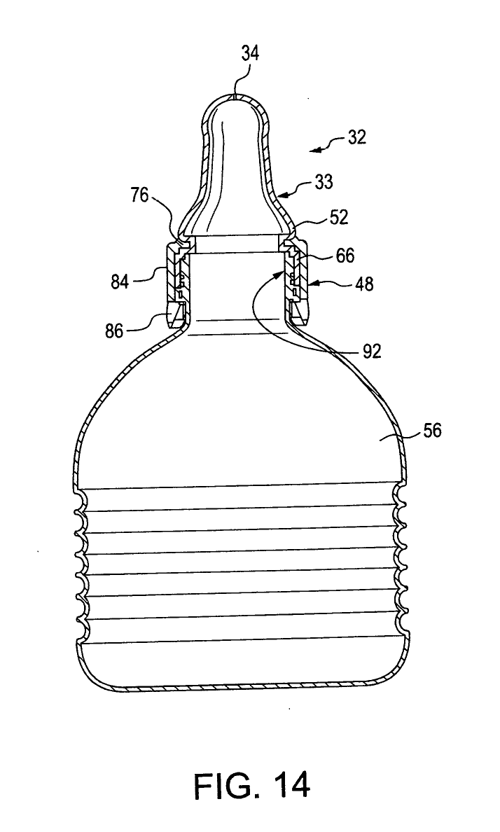

The flexibility of the skirt member provides for a third sealing engagement location at area 66 along the inner walls of the skirt member which contact the threads on the outside of the spout. This is accomplished, as shown in FIG. 14, when segments 84 of the clamping member 48 are disposed along and against the outside of the skirt. There, because the clamping member pushes segments 84 against the skirt 38, the skirt is in turn pressed against the threads on the outside of the spout and seals against any leakage of the bottle's contents there also.

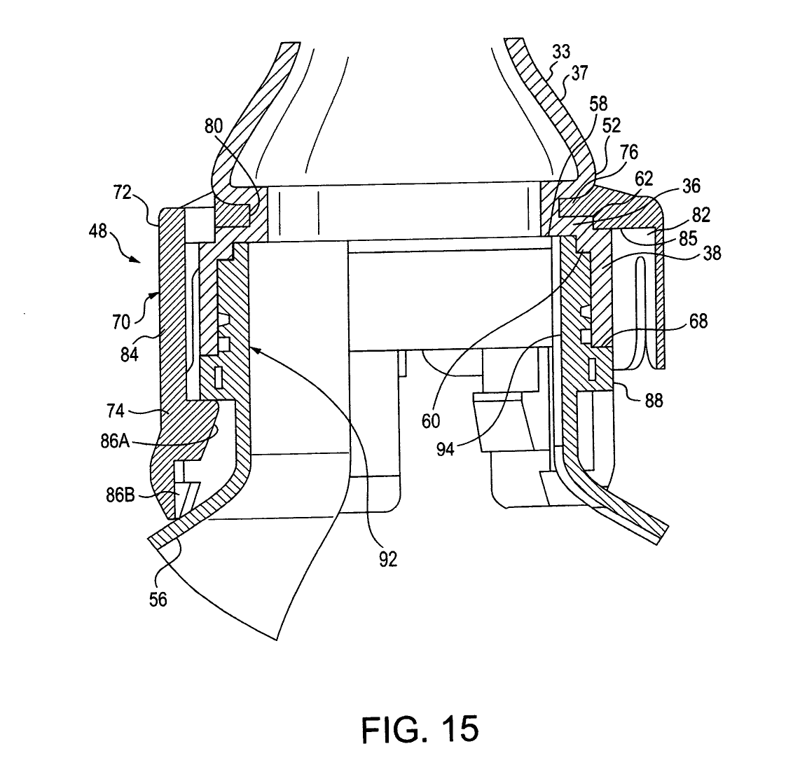

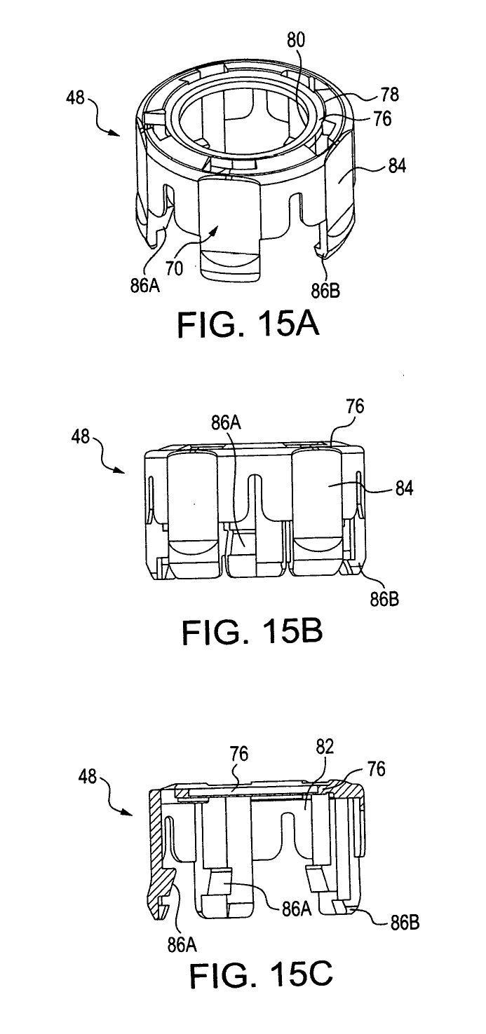

The distal extremities of the skirt member 38 may be drawn into a fourth sealing engagement point 68 when they are pressed against a fin or ring 88 frequently found on the outer walls of the spout some distance away from the second engagement point 60 and the threaded area on the outside of the spout. See FIGS. 12 and 15. Most bottle spouts include external threads or lugs which engage complementary threads or lug engagements inside the bottle caps. While it is advantageous to seal the inner walls 40 of the skirt member 38 against the bottle spout's threads or lugs, it is also helpful to bind the extremities of the skirt below the spout's threaded area. FIGS. 12 through 15 illustrate one form of clamping member 48 arranged to accomplish the fourth sealing engagement point adjacent to the ring 88.

In particular, as shown in FIG. 15, clamping member 48 includes a tubular shaped yoke portion 70 which fits onto the lower, second end 37 and around skirt member 38 of nipple 33. The yoke 70 has a first end 72 and a second end 74. A collar portion 76 of clamping member 48 is joined to the yoke's first end 72 along the collar portion's outer edges 78. The inner edges 80 of collar 76 extend inwardly from the walls 82 of yoke 70 adjacent to the first end 72 of the yoke toward the center of the tubular configuration of the yoke. The walls 82 are joined together around the first end 72 of yoke 70 along the collar portion's outer edges but are divided into individually moveable segments 84 toward and around the yoke's second end 74. There the distal ends of segments 84 are pivotally disposed from a fulcrum formed at the tubular portion's first end 72 at the junction between the segments 84 and the outer edges of collar 76. Each distal end of the segments 84 is provided with at least a lug 86A which may be supplemented by a lug 86B (collectively, lugs 86). The lugs 86 extend toward the center of the tubular configuration of yoke 70 substantially parallel to the plane of the collar portion 76 and are substantially coextensive with it. The lugs 86 form jaw members which engage either external threads on the bottle spout or engage a fin around the outside of the spout beyond the threads and cooperate with the collar portion 76 of clamping member 48 to pull the collar portion downwardly, thus clamping the collar portion firmly in place onto bottle spout 92. This clamping is accomplished when the yoke 70 formed by segments 84, extending between the collar portion 76 and lugs 86, urges the collar portion 76 down upon the base member 36 and presses it against the upturned edges of the spout 92.

The indent 62 assists in making a sealing engagement of the nipple 33's base member 36 on the upturned edges of the spout 92. A ledge 85 inside the clamping member 48's yoke 70 adjacent collar 76 engages the funnel member's indent 62 at the funnel member's second end 37 and presses the funnel member against the outwardly facing sides of spout 92. The pressure on ledge 85 to engage and press indent 62 against the spout is supplied when segments 84 of the clamping member 48 are pressed downwardly onto the spout 92. The lugs 86 on the segments 84 are spread outwardly when they pass over the threads on the outside of the spout but spring back and press inwardly as lugs 86 pass the threads on the spout and spring into clamping engagement on the spout below the threads as will now be described.

Commercially available bottles normally have a fin 88 on the bottle spout encircling the spout just below the threads on the spout. This construction is illustrated in FIG. 15 where the fm 88 on the spout 92 is arranged on the spout between the spout's threaded portion 94 and the body of bottle 56.

Fin 88 thus disposed may be utilized to clamp the nipple assembly 32 on a bottle. To do so, collar 76 of clamping member 48 is engaged in the channel 54 around funnel member 33 by inserting the funnel member's first end 35 through the collar until the inner edges of the collar are slipped past the funnel member's exterior ring element 52 and nested in the channel 54. Thus assembled, the unit 32 is pressed onto the uncovered spout of the bottle, lugs 86 of the segments 84 first, until lugs 86 are engaged over ring 88 on the spout and base member 36 of the funnel member 33 is seated on the upwardly facing edges of the spout. So disposed, each of the four sealing points 58, 60, 66 and 68 will be firmly engaged on the spout as described above.

A second embodiment 96 of a nipple unit assembly embodying the present invention is illustrated in FIG. 16. Clamping member 98 is embedded inside the flexible skirt 100 of the assembly 96 instead of being outside the skirt. A collar 102 of the clamping member is engaged in a base member 104 of the nipple shaped funnel member 106 inside the base member. There the collar 102 is in position to urge the base member 104 toward the upturned edges of a bottle spout (not shown) and hold the base member 104 in a sealing engagement on those edges.

The assembly 96 includes a flexible skirt member 100 which is joined to the underside of the assembly's base member 104 and sized to fit over and surround a bottle spout's exterior threads. An indent 110, located in the clamping member 98 near the junction of the skirt 100 and base member 104, is also connected to a separately moveable segment or leg portion 112 of the clamping member embedded in the skirt. The indent 110 is moveable toward the open end of the spout, and when it is urged in that direction by the leg portion of the clamping member it presses the inside of the skirt against the outwardly facing surfaces of the spout adjacent the spout's open end.

The leg portion 112 of clamping member 98 extends inside the skirt to the skirt's distal areas and is thus arranged to overlie a spout's externally threaded portions When the leg portion 112 springs toward the spout it not only urges the indent 110 to engage the outer walls of the spout but also seals the inner walls of the skirt against the threads and adjacent portions of the spout.

As shown in FIG. 16, the distal extremities of skirt 100 are provided with lugs 114 which are arranged to engage a fin or similar ring below the threaded area of a common water bottle spout. When the lugs are so engaged, drawing the base member 104 onto the upwardly facing bottle edges at the open end of the spout, the assembly 96 is firmly affixed on the spout, and leaks are avoided by the seals created at the base member of the assembly on the upwardly facing edges of the spout, at the indent, at the spout threads, and on any fin below the threads.

Although the invention described above has been shown and described with reference to certain preferred embodiments, those skilled in the art undoubtedly will find alternative constructions after reading this disclosure. The following claims are intended to define and cover the full scope of protection to which the inventor is entitled, and they should be deemed to include all equivalent embodiments.

I claim:

1. A nursing nipple assembly arranged for clip-on engagement to a spout on a water bottle comprising
a funnel member having an orifice at a first end for transmitting fluid out of the nipple,
a base member at a second end of the funnel member, and
a clamping member which includes
a funnel member engagement portion disposed on the funnel member,
a jaw portion engageable on the spout, and
a yoke portion connecting the funnel member portion and the jaw portion and urging the base member into sealing engagement on the spout.

2. The nursing nipple assembly of claim 1 in which
the funnel member engagement portion of the clamping member grasps the funnel member intermediate the base member and the first end of the funnel member.

3. The nursing nipple assembly of claim 1 in which
an external ring is disposed on the funnel member adjacent the base member and
the funnel member engagement portion of the clamping member is disposed between the external ring and the base member.

4. The nursing nipple assembly of claim 3 which includes
a collar on the funnel member engagement portion grasped between the external ring and the base member.

5. The nursing nipple assembly of claim 1 which includes
an indent on the base member and
a lug portion inside the clamping member engaging the indent and urging the base member onto the location of the spout inside the clamping member.

6. The nursing nipple assembly of claim 1 which includes
a tubular yoke portion surrounding the location of the spout inside the clamping member, and
a plurality of segments in the yoke portion pivotally moveable toward the location of threaded areas on the spout inside the clamping member and sealingly engageable on the threaded areas.

7. The nursing nipple assembly of claim 6 in which the segments include distal end portions moveable toward the location of a fin on the spout and sealingly engageable on the fm.

8. The nursing nipple assembly of claim 6 in which the segments include distal end portions moveable toward the location of a bottle cap locking ring on the spout and sealingly engageable on the ring.

9. The nursing nipple assembly of claim 1 in which the clamping member is enclosed and embedded in the assembly.
